(19) United States
(12) Patent Application Publication
(10) Pub. No.: US 2013/0159129 A1
(43) Pub. Date: Jun. 20, 2013

(54) ENDURANCE AUCTION SYSTEM AND METHOD

(71) Applicant: TitleAuction IP Holdings LLC, Naples, FL (US)

(72) Inventors: Daniel E. CARTER, Naples, FL (US); Lance J. LESTER, Naples, FL (US)

(73) Assignee: TitleAuction IP Holdings LLC, Naples, FL (US)

(21) Appl. No.: 13/714,835

(22) Filed: Dec. 14, 2012

Related U.S. Application Data
(60) Provisional application No. 61/576,351, filed on Dec. 15, 2011.

(51) Int. Cl. G06Q 30/08

(52) U.S. Cl. CPC G06Q 30/08
USPC 705/26.3

(57) ABSTRACT

An all-pay on-line auction encourages bids for auctioned property to be received throughout the auction by awarding bid behaviors. In an all-pay auction, bidders pay for each bid placed and the price of the auction property increases by an incremental amount. The final bid placed before the close of the auction has the right to acquire the auction property at the final price. In order to encourage bid placing throughout the duration of the auction, endurance bid behavior is monitored and accumulates the duration of high bids for each bidder. An award is provided to the bidder with the greatest accumulated duration. The award may be a right to purchase substantially similar property at the final price of the auction property. Additional awards may be provided for bidders placing a maximum number of bids and own-it-now credits allowing non-winning.

### RELATED APPLICATIONS

This patent application claims the benefit of, and priority to U.S. Provisional Application No. 61/576,351, which was filed on Dec. 15, 2011, the entire contents of which are hereby incorporated by reference into this patent application.

### TECHNICAL FIELD

The present disclosure relates to an electronic auction system and method that encourages end-users to bid often and throughout the bidding process, thus enabling the sale of high-value personal and real property.

### BACKGROUND

Electronic and on-line auctions have been in existence for many years, and many have modified such systems to encourage participation. In recent years, so-called “all-pay” auctions have proliferated with the growth of the Internet and Internet based auctions. In an all-pay auction, participants pay a non-refundable fee to place a bid. All-pay auctions include “bidding fee” and “bid-to-own” auctions. Also a “penny auction”, is a type of all-pay auction in which each non-refundable bid increases the price of the item being auction by one cent. When time expires and the auction closes, the last bidder to have placed a bid wins the item and pays the final bid price, which is purportedly significantly lower than the retail price or market value of the item. The auctioneer collects money in at least two ways: the fees for each bid and the payment for the winning bid.

During typical all-pay auctions, the majority of the bidders place bids towards the end of the auction in order to win the auction with a minimum number of bids. However, in order to maximize a fair opportunity to win the item and to maximize the value of the auctioned property, it is desirable to more motivate bidders to more evenly distribute the bids over the auction duration.

### OBJECTS OF THE DISCLOSURE

The following section of the written description describes some of the examples of the present disclosure, but the section is not exhaustive of all of disclosure's objects.

In one example the present disclosure provides an electronic or online auction system and method that promotes end users to participate in the bidding process throughout the pendency of the auction, thus enabling the sale of auction items in a timely manner, including auction items of high worth.

In another example the present disclosure provides an endurance auction reward system and method that determines at least one winning bid based upon an endurance algorithm that takes into account the bidder having the greatest cumulative time as the highest bidder throughout the auction process.

Another example of the present disclosure provides an own-it-now credit system which encourages users to bid by assuring them that even bidders who are unsuccessful at winning at auction through one of the auction methods described herein is to apply the monetary value or a credit based upon the value of to all unsuccessful bids placed on an auction item. The credit may be applied towards the purchase of any pre-auction product being offered on a web site.

### SUMMARY OF THE DISCLOSURE

The present disclosure is an electronic or online endurance auction system and method that awards the bidder who endured as the highest bidder for the longest cumulative duration of time during the pendency of a particular auction event. In other words, when the auction is over, the system and method of the present disclosure calculates which bidder was the highest bidder for the longest cumulative period of time and provide an award. Thus, the system and method encourages participants to bid early. The endurance auction model of the present disclosure not only awards the last bidder to place a bid before the time expires, but also permits the participating bidder that had remained “Highest Bidder” for the longest duration throughout the auction an opportunity to win the property being auctioned or another property of equal value.

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is an auction system block diagram with an auction server and bidder terminals coupled through a network.

FIG. 2 is a diagram of the stages of an auction, a sample sequence of received bid signals and corresponding endurance timer behavior.

FIG. 3 is a schematic of an example information processing system for use in embodiments of the present disclosure.

FIG. 4 is a flow diagram of an auction operating a set of endurance timers.

FIG. 5 is a recycling mode of auction timer adjustment during auction extension.

FIG. 6 is a ratcheting mode of auction timer adjustment during auction extension.

FIG. 7 is an alternative flowchart to FIG. 4 of an auction operating in a maximum bid count mode.

### DETAILED DESCRIPTION OF THE EMBODIMENTS

The present disclosure relates to a system and method for optimizing profit in an online auction. The embodiments of the disclosure described below are only examples of some of the uses of the teachings described herein. In general, statements made in the specification do not limit any of the various claimed subject matter. Moreover, some statements may apply to some inventive features but not to others. Unless otherwise indicated, singular elements may be in the plural and vice versa with no loss of generality. Similar reference numerals and letters represent similar components and system features throughout the drawings and the written description.

Generally, the method comprises identifying a property to be auctioned, providing a plurality of bid packs to a prospective auction participant, providing an auction server configured to accept fixed incremental bids, charging an auction participant for each incremental bid, establishing an actuating event that terminates the auction, providing criteria for establishing an auction winner.

In one example, the fixed incremental bids are one cent. Additionally, one example includes the actuating event as expiration of a fixed time period, expiration of a fixed number of incremental bids, combinations thereof, or an extension period based upon bids received towards the close of the auction.

The auction winner is determined in a variety of selected ways. Under one example of the present disclosure, each participant pays a non-refundable fee to place an incremental bid. When time expires, the last participant to have placed a final bid wins the item and also pays the final bid price, which is usually significantly lower than the retail price of the item.

This bid-to-win auction process provides a more interactive and exciting method to the end user which significantly improves the overall experience to the participant over the more traditional electronic and online auction websites. Bid-to-win auctions provide the end user the opportunity to purchase items at steep discounts using competitive bidding strategies with the intention of being the last bidder when time expires. Bid-to-win or all-pay auction websites embodying the present disclosure typically collects 150% or more of the market value of a product, because the system keeps the funds used from each unsuccessful bidder on any given product. Hence, each unsuccessful bid provides a source of revenue for the particular auction.

Unlike traditional auction sites which generate revenue from a percentage of the final auction selling price, the present disclosure has a revenue stream primarily of “bid packs” purchased, regardless of the final auction selling price. This “all-pay” auction model can translate into a much more lucrative profit margin.

In one example of an all-pay auction, the present disclosure is enabled through an interactive website that provides an auction for a variety of real and personal property types, including single family residential properties, multifamily residential properties, automobiles, watercraft, and motorcycles. By way of example, one example of the disclosure is as follows:

House X, which has a market value of $250,000.00, sells at auction for $8,000.00 to the highest bidder after the clock expires. The auction is in incremental penny auction.

Each bid costs $1.00 and the increments are $0.01. Thus, there are 100 bids in each dollar at auction. The $8,000 final selling price multiplied by 100 (100 incremental bids for every $1.00)=$800,000.00 bid revenue. Since each bid costs $1.00, in this example, the auction would have grossed $808,000.00 (the sum of $808,000 includes $800,000 auction assets and the final purchase price of $8,000). Thus, in the foregoing example, the system and method provide a net profit of $573,000.00 based on the following expression:

Gross revenues $808,000−$250,000(market value given to property seller)=$558,000 profit.

The present disclosure provides at least two ways to win on each auction:

Traditional—Last bidder to place a bid when time expires wins.

“Endurance Auction”—The user who spends the most time as the “highest bidder” also wins. This is a new form of bid-to-win auction unique to the current disclosure. In the endurance auction according to the present disclosure, a program instructs a computer to perform a method, the program may be stored on a computer readable medium, the method monitors each auction participant. A winning endurance bidder is determined not by the highest bidder at auction end, but by a calculation to determine a cumulative duration as the highest bidder. Duration is calculated by either actual or real time as the highest bidder, by the number of bids in which a bidder is the highest, or combinations thereof.

In one example of an endurance auction, the present disclosure is enabled through an interactive website that provides an auction for a variety of real and personal property types, including single family residential properties, multifamily residential properties, automobiles, watercraft, and motorcycles. By way of example, one example of the disclosure is a “title auction” where property ownership, such as real estate or automotive properties, is evidenced by title registration. In this example houses X and Y are unique first and second real estate properties each having comparable values of substantially $250,000.00 and selling in the same auction for a final purchase price of $8,000.00 to the highest bidder (Traditional) and the Endurance winner when time expires. Thus, properties X and Y unique real estate properties wherein the ownership of the first and second properties are evidenced by title registration. Properties considered to have comparable values may differ in market values by up to ten percent or more, or may be determined to be comparable at the discretion of the auctioneer service.

Each bid costs $1.00 and the increments are $0.01. Thus, there are 100 bids in each dollar at auction. The $8,000.00 final selling price multiplied by 100 (100 incremental bids for every $1.00)=$800,000.00 bid revenue. Since each bid costs $1.00, in this example, the auction would have grossed $816,000.00 (the sum of $808,000.00 includes $800,000.00 auction assets and the final purchase price of $16,000.00 for both properties). Thus, in the foregoing example, the system and method provide a net profit of $316,000.00 based on the following expression.

Gross revenues $816,000.00−$500,000.00(market value given to property sellers)=$316,000.00 profit.

According to one example of the present disclosure, products or the property at issue are available for direct purchase before they officially go up for auction.

“Own it now” prices are attractively priced relative to the surrounding market because the system consentrates on properties which have been affected by economic circumstances impacting the particular industry or type of property at issue. For example, in the real property arena, the system is particularly well-suited for the sale of real estate whose value was significantly diminished as a result of the housing downturn that began in 2008. Thus, by way of example, the system can be used to auction real property purchased in bulk at distressed prices. Thus, initial offerings are contemplated to be distressed multifamily real estate. It is further contemplated, at least initially, that an example of the present disclosure would focus on depressed real estate markets which present a great buying opportunity for acquiring many attractive, brand new products at deeply discounted prices.

In one example, bidders who are unsuccessful at winning an auction through one of the aforementioned auction methods apply the total monetary value corresponding to all used unsuccessful bids towards the purchase of any pre-auction product being offered on a web site.

In one example, the method of the present disclosure enables buying the product (homes and vehicles for example) and to streamline the auction-closing process.

While the disclosure is described with some degree of particularity, it is understood that this description has been given only by way of example and that numerous changes in the details of construction, fabrication, and use, including the combination and arrangement of parts, may be made without departing from the spirit and scope of the disclosure or the claimed subject matter.

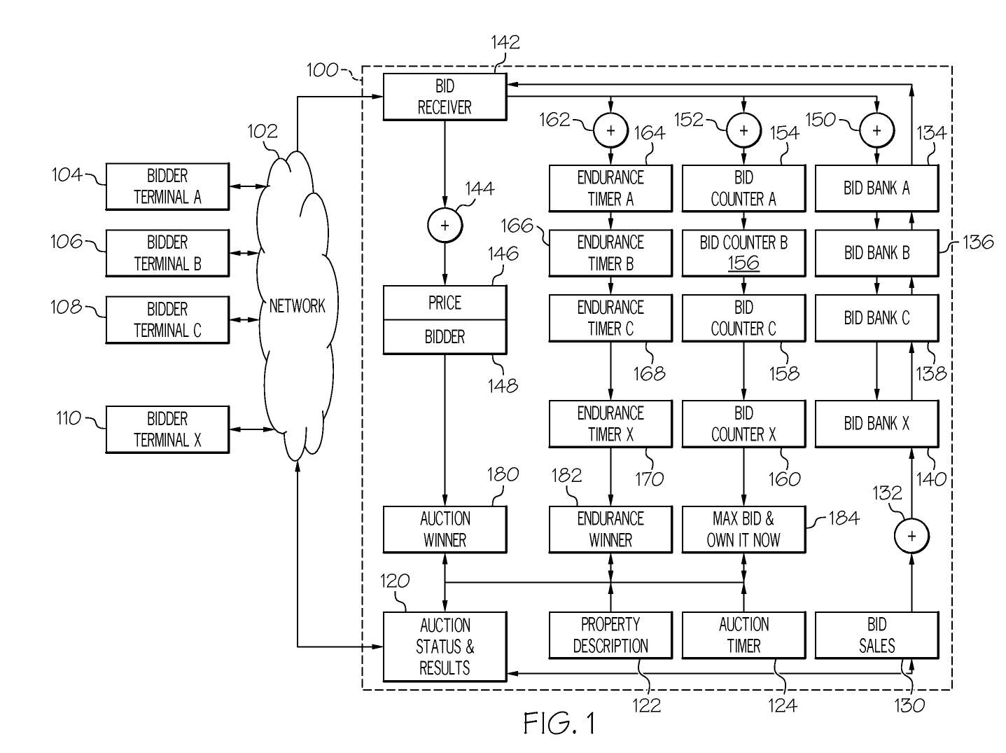

FIG. 1 shows an auction system block diagram with an auction server and bidder terminals coupled through a network. An auction server 100 is coupled through a network 102 to a multiplicity of bidder terminals 104-110 operated by perspective bidders. Network 102 may be the Internet or other wired and/or wireless network and include various network elements and nodes such as routers and switches. One or more edge network nodes/elements reside at the edge of the network to transfer traffic from the network to one or more edge networks, and visa versa. End network nodes such as routers and switches are communicatively coupled to the nodes and operate to interface the auction server with the bidder terminals. The auction server 100 may be a physical server implemented by a computer or may be a virtual server implemented by a server service that facilitates numerous server functions. Bidder terminals 104-110 may be personal computers, tablets, smart phones or other devices capable of interfacing to auction server 100 through a network an operating an application, such as a browser, capable of interfacing with the auction server. There may be as many bidder terminals as there are auction bidders.

Before an auction, auction status and results module 120 transmits information including a property description 122 of the property to be auctioned to the bidder terminals in order that the property may be evaluated by bidders using the bidder terminals.

The auction status and result module 120 facilitates communication of a number of other pieces of information in order to facilitate the auction including facilitating an interface with bid sales module 130. Bid sales module 130 facilitates the sale of bids to bidders using bidder terminals 104-110 before, during or after an auction. When bids are purchased, adder 132 adds bids associated with bidder terminals 104-110 to a corresponding set of bid banks 134-140 which tracks the number of available bids associated with each bidder terminal. For example, if bidder C associated with bid terminal C 108 wanted to buy a bid pack of five hundred bids at a cost of one dollar per bid, bid sales module 130 would facilitate completion of a financial transaction. A five hundred dollar purchase adds five hundred bids to bid bank C 138. Bidders participating in an all-pay auction with bidder terminals 104-106 have pre-paid bids in corresponding bid banks 134-140 which provide for an independently determined number of available bids for each bidder terminal.

Auction timer 124 acts as an auction duration timer that uses an auction duration time to open and close an auction and facilitate extension of the duration of the auction is described hereafter.

When an auction is opened, bid receiver 142 is responsible for reception of bid signals and receives signals from bid terminals and affects several processes. First, if a particular bid bank corresponding to a particular bidder terminal is depleted and does not have bids, then the received signal is not interpreted as a bid. In one example, the application operating in the bidder terminal may not enable to transmission of a bid signal, or in another example a bid signal may be rejected at the auction server by the bid receiver. If the bid bank is depleted, the auction status and results module 120 may initiate a financial transaction with an offer to the particular bidder terminal to purchase more bids. If the bid bank is not depleted then the bid is processed. Adder 144 uses the received bid to increase the bid value or property price 146 of the property. The price increase may be any amount. The increase may be fixed or set totally or in part in response to inputs from the bidder where the bidder either sets the new price or incremental amount of the price. In an all-pay penny auction, the increase in the price of the property is fixed to one penny per bid. Property price and bidder information associated with the last bid are stored in 146 and 148 respectively. Adder 144 and memory 146 acts as a price tracker for increasing the bid value of the auctioned property in response to each received bid signal. Also, in response to a bid from a bidder terminal, bid bank decrementer 150 removes the bid from the bid bank 134-140 associated with the bidder terminal by decrementing the total number of available bids in the bid bank. Also, in response to a bid from a bidder terminal, bid count incrementer 152 increments one of a set of bid counters 154-160 corresponding to each of the multiplicity of bidder terminals 104-110, allowing for tracking of the number of bids received from each bidder terminal. Further, in response to a bid from a bidder terminal, endurance timer enabler 162 enables the accumulation of time of one of a set of endurance timers 164-170 corresponding to each of the multiplicity of bidder terminals 104-110 and disables any of endurance timer that was running prior to reception of the bid. Endurance timers track bid time measurement of the duration of a winning bid submitted by a bidder operating a corresponding to a bidder terminal resulting in a winning bid time measurement. Each endurance timer tracks the time from reception of a received bid signal from a corresponding bidder terminal until a subsequent bid signal is received from another bidder terminal thereby performing a time measurement of the duration of a bid.

Auction timer 124 closes the auction at the end of a time interval causing a completion of the auction. The time interval may be fixed or adjustable to extend the duration of the auction. Two modes of auction extension include a recycling period and a ratcheting period are described. In one example the auction has a duration of seventy two hours. After seventy one hours and fifty eight minutes, or in the last two minutes, the auction duration may be extended. In the recycling mode, a bid received less than one minute before the end of the auction extends the auction up to thirty seconds, but not more than one minute total may remain on the timer. Bids received between one and two minutes before the end of the auction extend the auction thirty seconds. In the ratcheting mode, bids received in the final two minutes, one minute or thirty seconds of the auction extend the auction thirty seconds, fifteen seconds and seven seconds respectively. It should be appreciated that numerous other time thresholds and extension intervals are anticipated and within the scope of this disclosure.

Upon closing of an auction, auction winner module 180 determines the winning bidder and the price of the property from property price memory 146 and most recent bidder 148. The auction winner has the right to purchase the auction property at the final auction price. Endurance winner module 182 determines the endurance winner by determining which endurance timer has the greatest value and the corresponding bidder terminal. The endurance winner has the right to purchase another property of similar value to the auctioned property at the price of the auction property. Max bid and own it now module 184 analyzes the bid counters 154-160 to determine bidder terminal for send award notices for own-it-now credits and maximum number of bids. In one example, the maximum number of bids winner has the right to purchase another property of similar value to the auctioned property at the price of the auction property. Own-it-now credits allow bidders associated with corresponding bidder terminals to apply at least part of the value of the number of bid signals received in the auction to other properties or services. Credits may expire after a preset interval such as six months. In one example, awards may be available to the auction winner, the endurance winner, the maximum number of bids winner and credits available to own-it-now winners. In one example, no more than one award is granted to a bidder or corresponding bidder terminal. In other examples only the auction winner and the endurance winner or maxim number of bids winner may be awarded.

Upon determining winners, the auction status and results module 120 acts as a transmitter for transmitting auction result notifications of the purchase rights to the corresponding bidder terminals, thereby notifying bidders of the auction results.

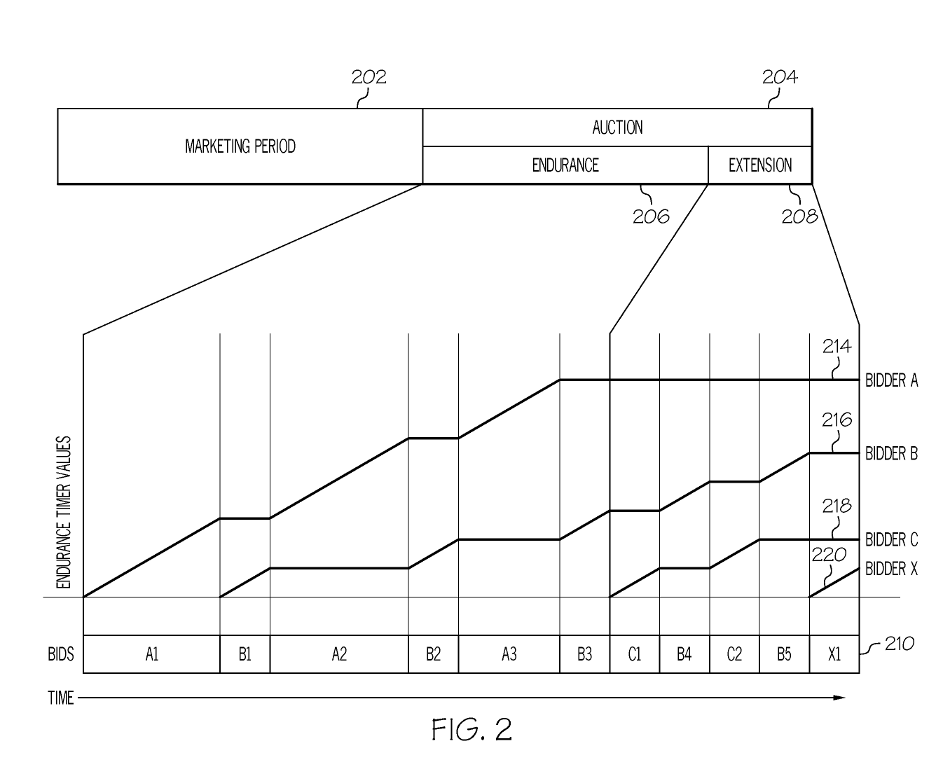

FIG. 2 shows a diagram of the stages of an auction, a sample sequence of received bid signals and corresponding endurance timer behavior. A marketing period 202 may begin two weeks before an auction begins. During the marketing period, property description information 122 about the property to be auctioned is provided. The property description continues through the auction and may be kept available after the auction. Auction 204 opens at the beginning of the endurance portion 206 and closes at the end of the extension mode or extension period 208. The auction is initially set for seventy two hours with a seventy one hour and fifty eight minute endurance interval. The extension period lasts at least two minutes and may extend for a substantially longer time depending upon bids received. Bid timing of bid signals from various bidders A, B, C and X at corresponding bidder terminals 104, 106, 108 and 110 are shown on bidder timeline 210 and values in corresponding endurance timer 164, 166, 168 and 170 are shown at lines 214, 216, 218 and 220, respectively. Bidder terminal A placed three bids during the endurance portion and held winning bids for the longest as shown by line 214 having the highest value. In this example, the bidder A is the endurance winner. Bidder B placed a total of five bids, more than any other bidder, and is thus the max bidder in an example that grants a max bidder awards. Bidder C placed two bids and would be eligible for an own-it-now credits in an example that grants own-it-now credits. Bidder X placed the last bid before the close of the auction and is thus the auction winner and has the right to purchase the auction property. FIG. 2 shows an exemplary auction, in an actual auction, the number of bidders, bidders terminals and the number of bids received may be substantially greater than shown in FIG. 2.

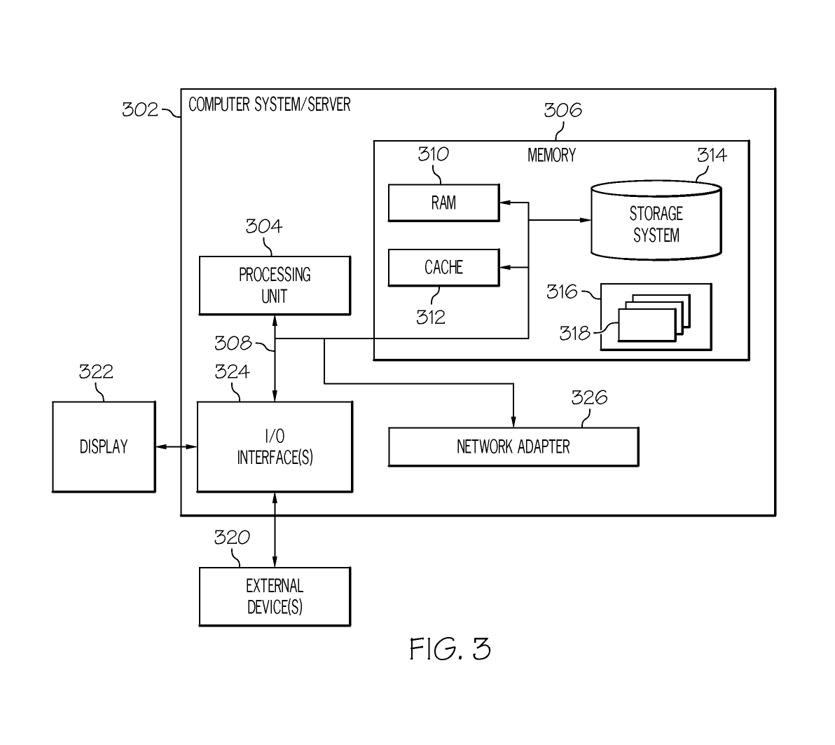

FIG. 3 shows a schematic of an example information processing system for use in examples of the present disclosure. Information processing system 302 is only one example of a suitable system and is not intended to limit the scope of use or functionality of examples of the present disclosure described above. The exemplary information processing system 302 is capable of implementing and/or performing any of the functionality set forth for auction server 100 or bidder terminals 104-110.

The information processing system 302 can be a networking node/element such as (but not limited to) the end network nodes, an edge network element, a personal computer system, a server computer system, a thin client, a thick client, a hand-held or laptop device, a tablet computing device, a smart phone, a multiprocessor system, a microprocessor-based system, a set top box, a programmable consumer electronic device, a network PC, a minicomputer system, a mainframe computer system, a distributed cloud computing system, or the like.

As illustrated in FIG. 3, the information processing system 302 is in the form of a general-purpose computing device. The components of the information processing system 302 can include, but are not limited to, one or more processors or processing units 304, a system memory 306, and a bus 308 that couples various system components including the system memory 306 to the processor 304.

The bus 308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The information processing system 302 typically includes a variety of non-transitory computer system readable media. Such media may be any available media that is accessible by the information processing system 302, and it includes both volatile and non-volatile media, removable and non-removable media.

The system memory 306, in one example, comprises a connection manager and its components, content service provider information, service state information, and a rules base and rules. These one or more components can also be implemented in hardware. The system memory 306 can include computer system readable media in the form of volatile memory, such as random access memory (RAM) 310 and/or cache memory 312. The information processing system 302 can further include other removable/non-removable, volatile/non-volatile computer system storage media. By way of example only, a storage system 314 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 308 by one or more data media interfaces. The system memory 306 can include at least one program product having a set of program modules that are configured to carry out the functions of an example of the present disclosure.

Program/utility 316, having a set of program modules 318, may be stored in system memory 306 by way of example, and not limitation, as well as an operating system, one or more application programs, other program modules, and program data. Each of the operating system, one or more application programs, other program modules, and program data or some combination thereof, may include an implementation of a networking environment. Program modules 318 generally carry out the functions and/or methodologies of examples of the present disclosure.

The information processing system 302 can also communicate with one or more external devices 320 such as a keyboard, a pointing device, a display 322, etc.; one or more devices that enable a user to interact with the information processing system 302; and/or any devices (e.g., network card, modem, etc.) that enable the information processing system 302 to communicate with one or more other computing devices. Such communication can occur via I/O interfaces 324. Still yet, the information processing system 302 can communicate with one or more networks such as a local area network (LAN), a general wide area network (WAN), and/or a public network (e.g., the Internet) via network adapter 326. As depicted, the network adapter 326 communicates with the other components of information processing system 302 via the bus 308. Other hardware and/or software components can also be used in conjunction with the information processing system 302. Examples include, but are not limited to: microcode, device drivers, redundant processing units, external disk drive arrays, RAID systems, tape drives, and data archival storage systems.

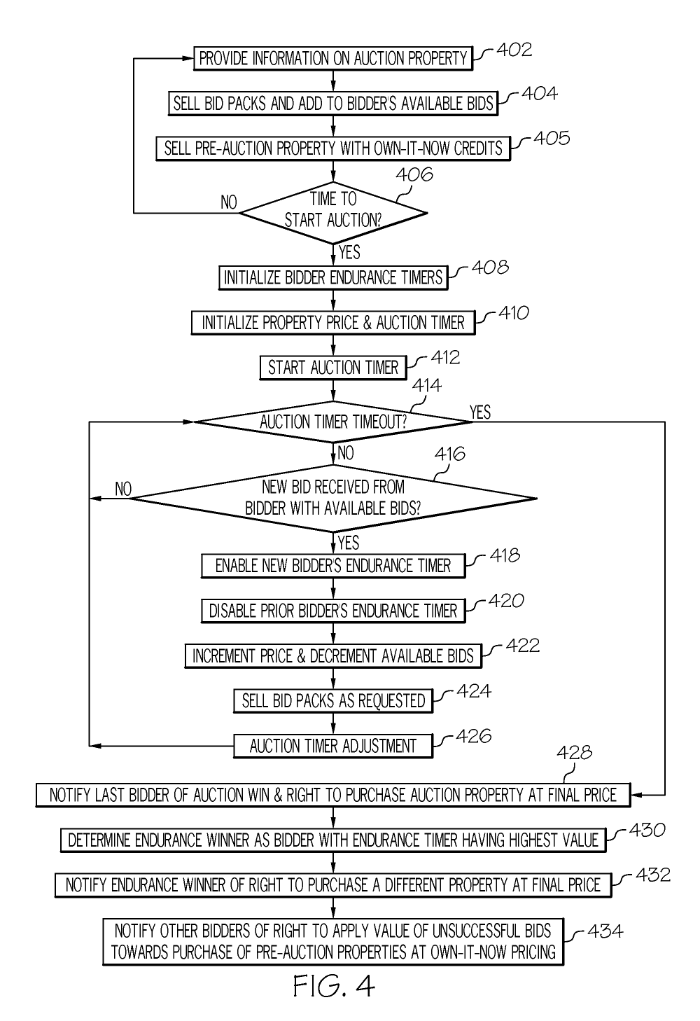

FIG. 4 shows a flow diagram of an auction operating a set of endurance timers. At step 402, information is provided on property including the property description 122 for the marketing period 202. Step 404 facilitates the sale of bid packs and records bid balances in bid banks 134-140. Step 405 facilitates the sale of pre-auction properties using own-it-now credits. If it is time for the auction to start at step 406, the auction is opened. Endurance timers 164-170 are initialize at step 408. The property price 146 and auction timer 124 are initialized at step 410 and the auction timer 124 started at step 412, thereby opening the auction.

Step 414 checks if the auction timer has timed out. If not, step 416 checks if a new bid signal has been received from a bidder terminal. The corresponding bid bank is also checked for available bids. If no bids are available then received signals are not registered as bids. Upon receiving a new valid bid signal, the bidder terminal's corresponding endurance timer is enabled at step 418. Any other endurance timer is disabled at step 420, thereby accumulating a bid endurance time associated with each bidder terminal. The property price 146 is incremented, corresponding bidder terminal 148 recorded and corresponding bid bank decremented at step 422. Step 424 facilitates the sale and recording of bid packs during the auction. Step 426 then checks if the auction timer 124 is to be adjusted as described in following figures.

Returning to step 414, if the auction timer has timed out then there as been a completion of the auction duration and the auction is closed. Step 428 determines the property winner using auction winner module 180. A notice is generated and sent to the bidder terminal from which the last valid bid signal was received prior to closing the auction. The notice indicates that the bidder has the right to purchase the property at the final price. Step 430 determines the winner of the endurance award as the bidder terminal associated with the highest value endurance timer. Note in one example endurance and auction winner awards are not sent to the same bidder terminal. If the highest value endurance timer is also associated with the auction property winner, then the endurance winner is selected as the bidder terminal with the next highest endurance timer accumulation. At step 432, a notification is generated and sent to the bidder terminal associated with the selected endurance timer indicating the right to purchase a property similar to the auction property at the final price of the auction property. Finally at step 434, own-it-now notifications are sent to remaining bid terminals.

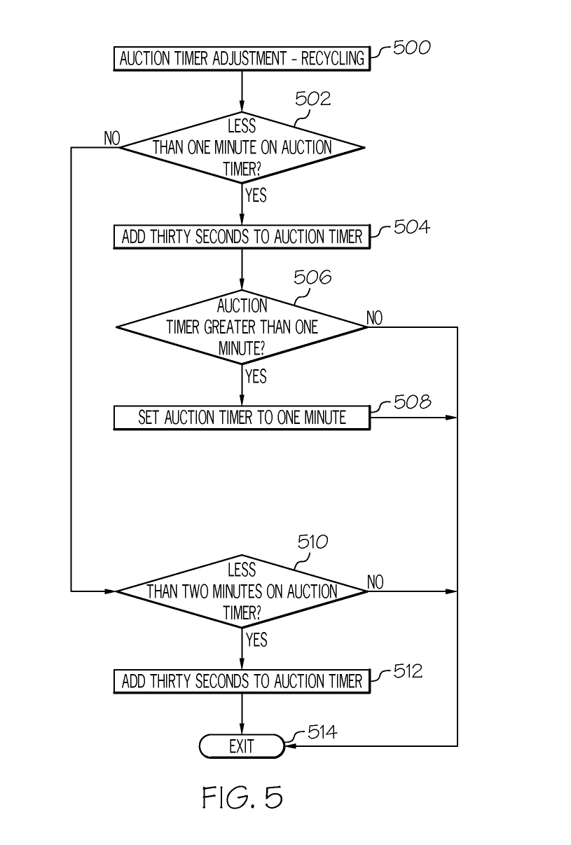

FIG. 5 shows a recycling mode of auction timer adjustment during auction extension. The recycling mode or period is entered at step 500 from step 426 of FIG. 4. Step 502 checks if there is less than one minute of time left on auction timer 124. If so, then thirty seconds is added to the auction timer at step 504 and the auction timer is checked to see if it now exceeds one minute at step 506. If not, then the flow exits at step 514. However, if the auction timer is more than one minute upon the addition of step 504, then the auction time is set to one minute at step 508 and the flow exits at step 514. Thus, once the auction timer is less than one minute it can be increased by up to thirty seconds upon receiving a new bid, but the increase is limited such that the auction timer does not be increased to a value greater than one minute. If at step 502, the auction timer is greater than one minute then step 510 checks if the auction timer is less than two minutes. If so, then step 512 adds thirty seconds to the auction timer and exits at step 514. If however at step 510 the auction timer is greater than two minutes then the flow exits at step 514 and no additional time is added to the auction timer, corresponding to the auction operating in the endurance mode 206. Timer additions of steps 504 or 512 correspond to the auction operating in the extension mode or extension period 208.

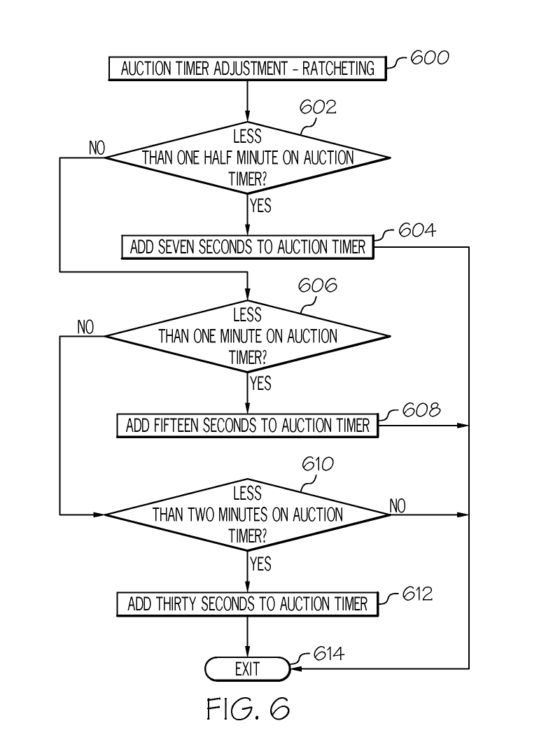

FIG. 6 shows a ratcheting mode of auction timer adjustment during auction extension. As an alternative example to the recycling mode of FIG. 5, the ratcheting mode is entered at step 600 from step 426 of FIG. 4. If less than thirty seconds or half of a minute is left on the auction timer at step 602, then seven seconds is added to the auction timer at step 604 and the flow exits at step 614. Otherwise, if less than one minute is left on the auction timer at step 606, then fifteen seconds is added to the auction timer at step 608 and the flow exits at step 614. Otherwise, if less than two minutes are left on the auction timer at step 610, then thirty seconds are added to the auction timer at step 612 and the flow exits at step 614. Otherwise, if more than two minutes are left on the auction timer then no additional time is added to the auction timer, indicative of the auction operating in the endurance mode 206. However, if the auction is operating in the extension mode or extension period 208 then additional time is added at steps 604, 608 or 612 in a ratcheting fashion.

FIG. 5 and FIG. 6 show two examples of an auction extension. It should be appreciated by those familiar with the art that the time thresholds and incremental time values may be modified, or a different method of auction extension contemplated while remaining within the scope of the claimed subject matter.

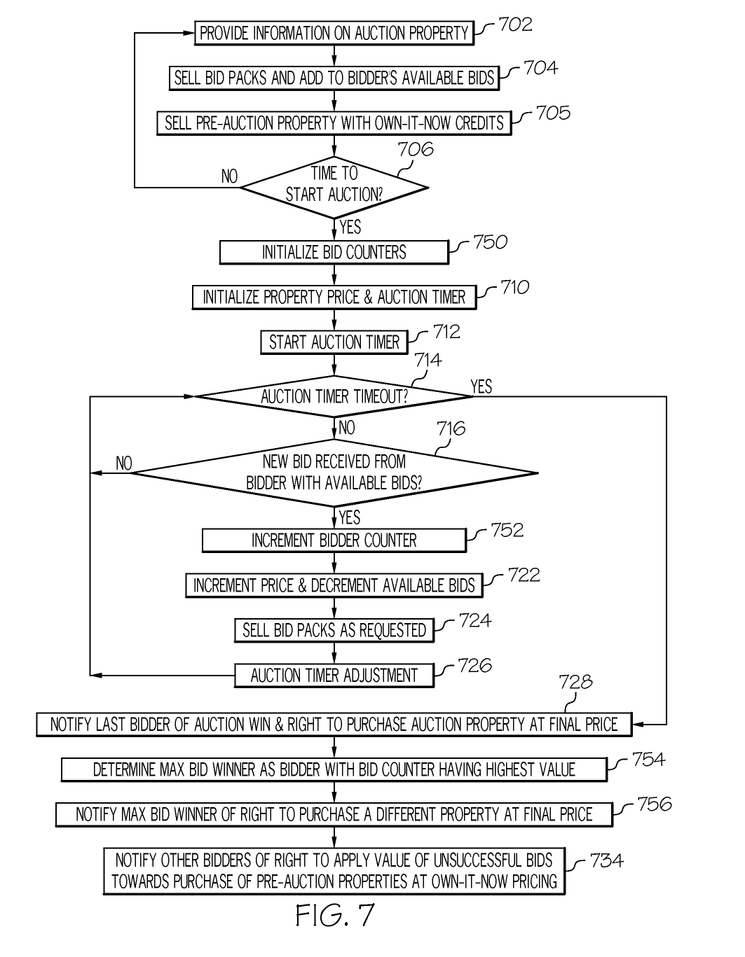

FIG. 7 shows an alternative flowchart to FIG. 4 of an auction operating in a maximum bid count mode. FIG. 4 describes an endurance timer mode which has many similarities to the maximum bid count mode of FIG. 7. Steps 702-706, 710-716, 722-728 and 734 are substantially identical to steps 402-406, 410-416, 422-428 and 434 of FIG. 4. Refer to the corresponding description of FIG. 4 for a description of these steps of FIG. 7. Upon opening the auction, step 750 initialized the bid counters 154-160. Step 752 increments a bid counter corresponding to the bidder terminal from which a new bid was received. Thus, the number of bids received from each bidder terminal during the auction is accumulated in bid counters 154-160. After the auction is closed, step 754 determines the max bid winner as the bidder terminal have a corresponding bid counter with the highest value. In one example, if the bid terminal is also the winner of the auction property, then the bid terminal associated with the next highest bid counter value is the max bid winner. Step 756 then generates and transmits a notice of a right to purchase a property similar to the auctioned property at a price equal to the price of the auction property.

It should be appreciated that examples that combine the processes of FIG. 4 and FIG. 7 are possible. Notices may be sent to auction winner bid terminal, the endurance winner bid terminal, the maximum bid count winner bid terminal and remaining own-it now bid terminals.

As can be appreciated by one familiar with the art, aspects of the present disclosure may be embodied as a system, method, or computer program product. Accordingly, aspects of the present disclosure may take the form of an entirely hardware example, an entirely software example (including firmware, resident software, micro-code, etc.) or an example combining software and hardware aspects that may all generally be referred to herein as a “circuit,” “module” or “system.” Furthermore, aspects of the present disclosure may take the form of a computer program product embodied in one or more durable non-transitory computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure have been discussed above with reference to flowchart illustrations and/or block diagrams of methods, apparatus (systems) and computer program products according to various examples of the disclosure. It can be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A method of providing auction result notifications of an auction for a first property, the method comprising:
accessing an auction duration time;
opening the auction for reception of bid signals;
receiving bid signals from a multiplicity of bidder terminals after opening the auction;
updating, with a processor, at least one endurance timer in a set of endurance timers in response to each of the bid signals received, each endurance timer accumulating a winning bid time measurement corresponding to a time between each bid signal received from a corresponding bidder terminal and a subsequent bid signal received from another bidder terminal of the multiplicity of bidder terminals;
increasing a bid value of the first property in response to each of the bid signals received;
closing the auction upon completion of the auction duration time;
transmitting a first auction result notification to a first bidder terminal from which a last bid was received prior to the closing of the auction; and
transmitting a second auction result notification to a second bidder terminal, the second bidder terminal corresponding to a one of the set of endurance timers having a maximum value upon the closing of the auction.

2. The method of claim 1 wherein the first auction result notification communicates a right to purchase the first property at the bid value occurring at the closing of the auction.

3. The method of claim 1 wherein the second auction result notification communicates a right to purchase a second property at the bid value occurring at the closing of the auction.

4. The method according to claim 3 wherein the first and second properties are unique real estate properties having comparable values.

5. The method according to claim 3 wherein ownership of the first and second properties are evidenced by title registration.

6. The method according to claim 1 wherein said step of accessing the auction duration time further comprises:
establishing a first duration time less than the auction duration time; and
extending the auction duration time during an extension period, the extension period occurring after the first duration time, wherein the auction duration time is extended in response to bid signals received from any of the multiplicity of bidder terminals during the extension period.

7. The method according to claim 6 wherein the auction duration time is seventy two hours and the first duration time is seventy one hours and fifty eight minutes and the auction duration time is extended up to thirty seconds in response to bid signals received from the multiplicity of bidder terminals during the extension period.

8. The method according to claim 1 wherein each of the multiplicity of bidder terminals has an independently determined number of available bids associated therewith and the number of available bids associated with a particular bidder terminal is decreased upon reception of a valid bid signal from the particular bidder terminal and further wherein signals received from the particular bidder terminal are not processed as bid signals if the number of available bids associated with the particular bidder terminal are depleted.

9. The method according to claim 8 wherein the number of available bids associated with the particular bidder terminal is increased upon completion of a financial transaction.

10. The method according to claim 1 further comprising:
counting a number of bid signals received from each of the multiplicity of bidder terminals; and
transmitting a third auction result notification to an at least one bidder terminal of the multiplicity of bidder terminals not being transmitted either the first or second auction result notifications, the third auction result notification indicating a credit for a subsequent purchase, the credit having a value corresponding to the number of bid signals received from the at least one bid terminal.

11. The method according to claim 1 wherein the bid value increases by one cent for each of the bid signals received.

12. An auction server for providing auction result notifications of an auction for a first property comprising:
an auction timer for accessing an auction duration time;
a bid receiver for opening the auction for reception of bid signals and receiving bid signals from a multiplicity of bidder terminals after opening the auction;
a set of endurance timers, at least one endurance timer in the set of endurance timers being updated in response to each of the bid signals received, each endurance timer accumulating a winning bid time measurement corresponding to a time between each bid signal received from a corresponding bidder terminal and a subsequent bid signal received from another bidder terminal of the multiplicity of bidder terminals;
a price tracker for increasing a bid value of the first property in response to each of the bid signals received;
said bid receiver further for closing the auction upon completion of the auction duration time; and
an auction status and result module for transmitting a first auction result notification to a first bidder terminal from which a last bid was received prior to the closing of the auction, and transmitting a second auction result notification to a second bidder terminal, the second bidder terminal corresponding to a one of the set of endurance timers having a maximum value upon the closing of the auction.

13. The auction server of claim 12 wherein the first auction result notification communicates a right to purchase the first property at the bid value occurring at the closing of the auction.

14. The auction server of claim 13 wherein the second auction result notification communicates a right to purchase a second property at the bid value occurring at the closing of the auction.

15. The auction server according to claim 14 wherein the first and second properties are unique real estate properties having comparable values.

16. The auction server according to claim 14 wherein ownership of the first and second properties are evidenced by title registration.

17. The auction server according to claim 12 wherein said auction timer sets the auction duration time by establishing a first duration time less than the auction duration time and extending the auction duration time during an extension period, the extension period occurring after the first duration time, wherein the auction duration time is extended in response to bid signals received from any of the multiplicity of bidder terminals during the extension period.

18. The auction server according to claim 17 wherein the auction duration time is seventy two hours and the first duration time is seventy one hours and fifty eight minutes and the auction duration time is extended up to thirty seconds in response to bid signals received from the multiplicity of bidder terminals during the extension period.

19. The auction server according to claim 12 further comprising a set of bid banks, wherein each of the multiplicity of bidder terminals has an independently determined number of available bids stored in a corresponding one of the set of bid banks and the number of available bids associated with a particular bidder terminal is decreased upon reception of a bid signal from the particular bidder terminal and further wherein signals received from the particular bidder terminal are not processed by as bid signals by said bid receiver if the number of available bids associated with the particular bidder terminal are depleted.

20. The auction server according to claim 19 wherein the number of available bids associated with the particular bidder terminal is increased upon completion of a financial transaction.

21. The auction server according to claim 12 further comprising:
a set of bid counters correspond to each of the multiplicity of bidder terminals, each of the set of the set of bid counters for counting a number of bid signals received from a corresponding bidder terminal; and
said auction status and results module for transmitting a third auction result notification to an at least one bidder terminal of the multiplicity of bidder terminals not being transmitted either the first or second auction result notifications, the third auction result notification indicating a credit for a subsequent purchase, the credit having a value corresponding to the number of bid signals received from the at least one bid terminal.

22. The auction server according to claim 12 wherein the bid value increases by one cent for each of the bid signals received.

23. A durable, non-transitory computer readable storage medium comprising a computer program which instructs a computer to perform a method of providing auction result notifications of an auction for a first property, the method comprising:
accessing an auction duration time;
opening the auction for reception of bid signals;
receiving bid signals from a multiplicity of bidder terminals after opening the auction;
updating at least one endurance timer in a set of endurance timers in response to each of the bid signals received, each endurance timer accumulating a winning bid time measurement corresponding to a time between each bid signal received from the corresponding bidder terminal and a subsequent bid signal received from another bidder terminal of the multiplicity of bidder terminals;
increasing a bid value of the first property in response to each of the bid signals received;
closing the auction upon completion of the auction duration time; and
transmitting an auction result notification to a bidder terminal corresponding to a one of the set of endurance timers having a maximum value upon the closing of the auction.

24. The computer program according claim 23 wherein the auction result notification communicates a right to purchases a second property at the bid value of the first property occurring at the closing of the auction.

25. The computer program according to claim 24 wherein the first and second properties are unique real estate properties having comparable values.
